(19) United States
(12) Patent Application Publication
(10) Pub. No.: US 2017/0145236 A1
(43) Pub. Date: May 25, 2017

(54) Cyan Colorant Composition Having Improved Chroma And Hue, Pigment Composition Therefor, And Use Thereof For Forming Images

(71) Applicant: CLARIANT INTERNATIONAL LTD., Muttenz (CH)

(72) Inventor: Daisuke Harada, Shimada City (JP)

(73) Assignee: CLARIANT INTERNATIONAL LTD., Muttenz (CH)

(21) Appl. No.: 15/323,825

(22) PCT Filed: Jun. 25, 2015
(86) PCT No.: PCT/EP2015/064403

§ 371 Date: Jan. 4, 2017

(30) Foreign Application Priority Data
Jul. 8, 2014 (JP) 2014-140392

(51) Int. Cl. C09D 11/50; C09B 67/22; C09K 11/02; G03G 9/09; C09D 11/322; C09D 11/328; C09D 11/104; C09D 11/037; C09B 67/08; C09K 11/06

(52) U.S. Cl. CPC C09D 11/50; C09B 67/001; C09B 67/0033; C09K 11/02; C09K 11/06; C09D 11/322; C09D 11/328; C09D 11/104; C09D 11/037; G03G 9/0918

(57) ABSTRACT

A colorant composition comprising a copper phthalocyanine pigment, a fluorescent dye, and a resin binder, wherein the hue angle of a coating from the composition on white paper is 236° or less, and the fluorescent material provides a maximum reflectance of 90 to 130% in the visible reflection spectrum of a coating film consisting of the fluorescent dye and the resin binder without comprising the copper phthalocyanine pigment.

### TECHNICAL FIELD

The present invention relates to a cyan colorant composition with copper phthalocyanine, a pigment composition therefor, and use thereof for forming images.

### BACKGROUND ART

Methods for forming or displaying images by the subtractive color process using printing inks, coating materials, electrophotographic toner, ink-jet inks, or the like are performed by the combination of three primary colors yellow (Y), magenta (M), and cyan (C) or by the further combination of these colors with black (K). For enhancing the color reproducibility thereof, use of a colorant having high lightness (L*), chroma (C*), and hue (H*) for each of the three primary colors is preferred. Copper phthalocyanine pigments, typically including C.I. Pigment Blue 15:3, which have high coloring power and high light resistance and durability and are inexpensive, have heretofore been used widely as such cyan colorants (Patent Document 1). However, some problems have been pointed out as to the copper phthalocyanine pigments. For example, ordinary copper phthalocyanine pigments, as compared with copper phthalocyanine dyes, have a wide absorption spectrum and lower chroma due to their aggregation effects. Furthermore, these pigments are more bluish than the standard cyan color. Therefore, there are needs for rendering the color of the pigments close to the standard color of cyan by adding greenishness or for using them as green color materials by further strengthening the greenishness.

Particularly, when images represented on a color display such as a liquid crystal display are printed on a color printer, the color reproduction range of the printer ink (YMC color space) is narrower than the color reproduction range on the color display (RGB color space) and, due to this, printed matter tends to have less sharp print images. One of the causes thereof is allegedly that the chroma of colorants for image formation used in printers is low; thus, the color reproduction range is small.

In general, it is possible for hard copies from a personal computer or the like to change their color representation depending on the type of colorants for image formation thereof as well as even on color management within the personal computer. For example, images with strong greenishness can be obtained by strengthening the greenishness of the hue of a colorant pigment in inks or by adjusting the printed areas of cyan and yellow pixels. Furthermore, the lightness is also controllable by adjusting colorants in inks, the hue of printing paper, pixel areas, etc. The chroma of images can be adjusted, for example, by applying fluorescent materials onto printing paper, but it is not easy to increase the chroma of pixels themselves. For increasing the chroma, use of colorants having high color purity is the most general method under the present circumstances. For this purpose, it is preferred to use dyes having a sharp absorption spectrum, but dyes have problems such as poor weather resistance. On the other hand, in the case of pigments having favorable light resistance, their properties such as weather resistance are improved by aggregating pigment molecules. As a result, however, the absorption spectrum width is increased, and the color purity is reduced. Therefore, many attempts have been made to improve the chroma by adjusting the aggregation structures, though the improved chroma falls short of the chroma of coloring dyes.

As for copper phthalocyanine, attempts have been made to increase the greenishness or improve the chroma via the optimization of its crystal form without changing the central metal copper. As a result, pigments having a hue considerably close to the cyan of process inks have been obtained, as with current β-copper phthalocyanine, but strong demands for high chroma have not yet been satisfied.

In response to the needs as described above, it is also possible to introduce substituents such as halogen atoms to unsubstituted copper phthalocyanine pigments. As one example, it is also possible to add, for example, chlorine atom-added Phthalocyanine Green. This is effective for increasing the greenishness, but is less effective for enhancing the chroma (C*). Furthermore, co-use of such pigments tends to present problems such as reduction in sharpness or reduction in dispersion stability.

A method for replacing the copper atom with a polyvalent metal such as aluminum or zinc is disclosed as another approach of improving the disadvantages of copper phthalocyanine pigments (Patent Document 2). Although this method may be capable of improving the chroma and adding greenishness, the pigment thus obtained is difficult to use practically. This is because this pigment is inferior in weather resistance to copper phthalocyanine and inevitably increases cost.

Accordingly, instead of the modification of copper phthalocyanine pigments as described above, it is also considered to add a dye such as a yellow dye in order to confer greenishness. The addition of yellow dyes is effective for adding the greenishness, but entails side effects such as reduction in chroma.

As a further alternative approach in response to the above needs, a system with a fluorescent dye added is also considered, as shown in Patent Document 3. However, the document does not make any mention about the characteristics or ratio of the fluorescent dye to be added in order to obtain the required hue and chroma without entailing other serious side effects.

As mentioned above, for conventional colorants using a copper phthalocyanine pigment, it have been strongly demanded to increase greenishness in their hue and, at the same time, to improve their chroma. However, colorants that satisfy the above needs without adversely affecting characteristics such as weather resistance or cost have not yet been obtained.

The above description relates to the problems of the current copper phthalocyanine pigments in the case of making hard copies from digital printers as an example. Similar needs are also widely found in the fields of offset printing, coating materials, etc.

As mentioned above, as for copper phthalocyanine pigments, particularly, unsubstituted copper phthalocyanine pigments, in particular, β-copper phthalocyanine pigments having favorable properties such as weather resistance and also being inexpensive, there are strong needs for (1) improving the chroma and (2) strengthening greenishness in their hue. Such colorants would be able to replace the conventional cyan colorants for electrophotographic toner or ink jet inks to simplify color matching and to obtain more colorful color images. Furthermore, if C inks among the C, M, Y, and K inks in conventional process inks can be replaced with ones having high chroma, many uses such as colorants for high-chroma secondary color, for example, green color, are expected.

### LIST OF RELATED ART DOCUMENTS

### Patent Document

[Patent Document 1] JPH09188828A

[Patent Document 2] JP2004027016A

[Patent Document 3] JP2008231211A

### SUMMARY OF INVENTION

### Problem to be Solved by the Invention

An object of the present invention is to provide a pigment composition that can achieve at least one of the following effects in relation to colorants containing copper phthalocyanine, particularly, unsubstituted copper phthalocyanine, in particular, β-copper phthalocyanine pigments:

1) the chroma can be improved; and
2) a color closer to the standard cyan color can be obtained by adding greenishness to the blue color without entailing reduction in chroma.

More specifically, an object of the present invention is to obtain a colorant that can control a hue angle from 236 degrees to, for example, 180 degrees, and can improve the chroma as compared with phthalocyanine pigments.

### Means for Solving the Problems

The present inventors have conducted diligent studies to solve the disadvantages of the conventional techniques in light of these situations and consequently obtained guidelines given below for attaining the object of the present invention.
(1) Improvement in chroma by using fluorescent dye in combination It has been found that the addition of a fluorescent dye to a copper phthalocyanine pigment contributes to the attainment of the above object. Particularly, use of a yellow fluorescent dye having a maximum wavelength of emission spectrum that falls within the range of 490 to 550 nm in reflection spectrum measurement has been found to be able to increase the chroma while decreasing the hue angle.
(2) The reflectance at the maximum wavelength within the range of wavelengths 490 nm to 550 nm in reflection spectrum measurement is preferably 90% or more and preferably 130% or less. A reflectance less than 90% is less effective for improving the chroma. At a reflectance exceeding 130%, fluorescence is too strong so that so-called feeling of glare is conspicuous.
(3) For the fluorescent dye, it is desirable that its absorption maximum wavelength should fall within the range of 380 to 450 nm. This is because, for example, use of a colorless or nearly colorless fluorescent dye having an absorption maximum wavelength less than 380 nm increases so-called Stokes shift, and in this case, a fluorescent dye capable of emitting green color is difficult to obtain. This is also because, since a fluorescent dye having λmax of 380 to 450 nm is yellow, the addition thereof can easily change the hue angle of a copper phthalocyanine pigment colorant toward 180 degrees. When the absorption maximum wavelength λmax of the fluorescent dye is present at a wavelength longer than 450 nm, the tone becomes cloudy and the chroma is reduced.
(4) It has further been found that, when the obtained images are observed under different light sources having various color temperatures, it is preferred that the emission wavelength of the fluorescent dye to be added should fall within the range of 490 to 550 nm, and there is a preferred range for the amount of the fluorescent dye added.

On the basis of these experimental guidelines, the present inventors have searched for a fluorescent dye that can strengthen greenishness in the hue of a copper phthalocyanine pigment-containing colorant and appropriately improve the chroma. The present inventors have further searched for the optimum compositional ratio between such a fluorescent dye and a copper phthalocyanine pigment.

Specifically, the present invention relates to:
1. A colorant composition comprising a copper phthalocyanine pigment, a fluorescent dye, and a resin binder, wherein the hue angle of a coating from the composition on white paper is 236° or less, and the fluorescent dye provides a maximum reflectance of 90 to 130% in the visible reflection spectrum of a coating film consisting of the fluorescent dye and the resin binder without comprising the copper phthalocyanine pigment.
2. A colorant composition as set forth in the above 1, wherein the amount of the fluorescent dye is 0.05 to 10 parts by weight relative to 100 parts by weight of the copper phthalocyanine pigment.
3. A colorant composition as set forth in the above 1 or 2, wherein the copper phthalocyanine pigment comprises unsubstituted copper phthalocyanine.
4. A colorant composition comprising a copper phthalocyanine pigment, a fluorescent dye, and a resin binder, wherein
   the copper phthalocyanine pigment comprises unsubstituted copper phthalocyanine,
   the fluorescent dye comprises a yellow fluorescent dye, and
   the amount of the fluorescent dye is 0.05 to 10 parts by weight relative to 100 parts by weight of the copper phthalocyanine pigment.
5. A colorant composition as set forth in the above 4, wherein the hue angle of a coating therefrom on white paper is 236° or less.
6. A colorant composition as set forth in the above 4 or 5, wherein the fluorescent dye provides a maximum reflectance of 90 to 130% in the visible reflection spectrum of a coating film consisting of the fluorescent dye and the resin binder without comprising the copper phthalocyanine pigment.
7. A colorant composition as set forth in the above 1 to 6, wherein the maximum reflection wavelength in the visible reflection spectrum of a coating film consisting of the fluorescent dye and the resin binder falls within the range of 490 to 550 nm.
8. A colorant composition as set forth in any of the above 1 to 7, wherein the copper phthalocyanine pigment comprises β-copper phthalocyanine.
9. A colorant composition as set forth in the above 1 to 8, wherein the absorption maximum wavelength of the fluorescent dye falls within the range of 380 to 450 nm.
10. A colorant composition as set forth in any of the above 1 to 9, wherein the fluorescent dye does not have an absorption at a wavelength longer than 450 nm.
11. A colorant composition as set forth in any of the above 1 to 10, wherein the fluorescent dye is selected from a coumarin, a stilbene, and a naphthalimide.
12. A colorant composition as set forth in the above 11, wherein the fluorescent dye is selected from Solvent Yellow 98, Solvent Yellow 160:1, Solvent Yellow 33, Solvent Yellow 98, Solvent Yellow 131, and Solvent Yellow 135.
13. A colorant composition as set forth in any of the above 1 to 12, wherein the resin binder is selected from a polyolefin, a polyester, a styrene resin derivative, an acrylic resin derivative, a styrene-acryl copolymer, and a urethane resin.
14. A colorant composition as set forth in any of the above 1 to 13, wherein when the colorant is applied onto white paper, the hue difference ΔE between the hue of the coating under the daylight color light source D65 (color temperature=6500° K) and the hue under the room light-type light source A10 (color temperature=3000° K) is 10 or less.
15. A pigment composition for use in preparing a colorant composition as set forth in any of the above 1 to 14, the pigment composition comprising an unsubstituted copper phthalocyanine pigment and a yellow fluorescent dye, wherein the composition comprises 0.05 to 10 parts by weight of the yellow fluorescent dye relative to 100 parts by weight of the unsubstituted copper phthalocyanine pigment.
16. Use of a colorant composition as set forth in any of the above 1 to 14 or a pigment composition as set forth in the above 15 for forming images.

### Advantageous Effects of Invention

According to the present invention, higher chroma is obtained as compared with the conventional coloring materials containing copper phthalocyanine. In addition, a phthalocyanine pigment-based colorant having strengthened greenishness can be obtained. This colorant can not only be used in various image formation applications including printing inks, toner, ink jet inks, and the like, but may be used in other applications such as coating materials. For example, cyan for a process ink closer to the ideal hue of cyan can expand the reproducible gamut of color, and such an ink can be used as a high-color rendering ink.

### MODE FOR CARRYING OUT THE INVENTION

Accordingly, the present invention relates to a coloring composition comprising at least a copper phthalocyanine and a fluorescent dye, wherein as for the hue thereof in color space coordinates (L*C*H* coordinates), the angle of hue H falls within the range of 236° or less. This coloring composition contains a copper phthalocyanine, a fluorescent dye, and a binder as essential components.

The hue H described in the present invention is indicated by a hue angle in L*C*H* color space. The hue angle of the standard color of cyan is present around 233 to 235° in terms of, for example, Japan Color specified by the Japan Machinery Federation. The hue angle of unsubstituted copper phthalocyanine is mostly within the range of 255 to 236°, particularly, 250 to 236°, which is slightly larger than that of the standard color, and the hue angle of β-copper phthalocyanine preferably used in the present invention is around 236°. Incidentally, the hue angle of 180° corresponds to green.

When the hue angle of the colorant composition exceeds 236°, this colorant composition is more bluish and has difficulty in reproducing the color of color images. In addition, use of an inexpensive pigment such as β-copper phthalocyanine is difficult. Furthermore, it is preferred that the hue angle of the colorant composition of the present invention should be 180° or more. This is because for setting the hue angle to less than 180°, it is necessary to add the fluorescent dye in a large amount, resulting in large hue difference between different light sources for observation as well as serious side effects such as the feeling of glare.

The copper phthalocyanine pigment of the present invention refers to one having a chemical structure in which 4 indole rings are bonded via a copper atom. Many polymorphs including types α, β, δ, and ε are present according to preparation processes, and any of them can be used in the present invention. In particular, type β with greenishness is widely used in process inks and the like and is particularly preferred for the present invention because of its favorable performance such as weather resistance, inexpensiveness, and easy availability.

The color pigment that can be used in the present invention is not limited as long as it is a copper phthalocyanine pigment having cyan color. However, unsubstituted copper phthalocyanine having no substituent on the indole rings is preferred. Particularly, a β-copper phthalocyanine pigment called C.I. Pigment Blue 15:3 as the generic name is preferred because of its high performance such as weather resistance and inexpensiveness.

The process for preparing the β-copper phthalocyanine preferred for the present invention is described in, for example, Patent Document 1. The copper phthalocyanine pigment of the present invention is particularly preferably β-copper phthalocyanine C.I. Pigment Blue 15:3 or 15:4 and may be further used, if necessary, in combination with additional copper phthalocyanine having a different crystal form, such as C.I. Pigment Blue 15, C.I. Pigment Blue 15:1, C.I. Pigment Blue 15:2, C.I. Pigment Blue 15:5, or C.I. Pigment Blue 15:6. Moreover, the copper phthalocyanine pigment of the present invention may be used in combination with a color pigment other than the copper phthalocyanine for the purpose of, for example, adjusting the hue.

The particle size, surface area, and other parameters of the copper phthalocyanine pigment of the present invention can be within the respective ranges described in Patent Documents 1 and other copper phthalocyanine pigment-relating documents. The pigment is used after being mixed with a dispersing agent, a solvent, a resin, etc. and dispersed under a high shearing force to a level suitable for intended applications. For example, the pigment may be dispersed until a particle size on the order of 100 nm to 1000 nm as measured by a laser-system particle size measurement apparatus, and then used as a dispersion.

A colorless fluorescent dye and/or a yellow fluorescent dye can be used as the fluorescent dye of the present invention. The colorless fluorescent dye is preferably used when improving the chroma or lightness of the copper phthalocyanine pigment without largely changing the hue of the copper phthalocyanine pigment. In this context, the colorless dye preferably one whose absorption coefficient at a wavelength of 450 nm is 5% or less relative to the absorption coefficient at the maximum absorption wavelength. Such a dye is appropriately selected from dyes known as optical brighteners. Examples thereof include stilbene compounds such as C.I. FB367 and C.I. FB368, and biphenyl, pyrazoline, coumarin, naphthalimide and oxazoline compounds.

The fluorescent dye of the present invention can be used for improving the chroma of the copper phthalocyanine pigment without largely changing the hue of the copper phthalocyanine pigment and is also preferably used for decreasing the hue angle thereof. Particularly, the yellow fluorescent dye used in the present invention is preferably used in improving the chroma of the copper phthalocyanine while shifting the hue from blue to green. For largely shifting the hue of the copper phthalocyanine to green, it is generally possible to mix the pigment with a green dye such as Phthalocyanine Green (C.I. Pigment Green 7 or C.I. Pigment Green 36) or an additional yellow pigment. However, mixing with such other pigments may tend to cause side effects such as reduction in chroma or poor pigment dispersion. Therefore, use of the yellow fluorescent dye of the present invention is preferred for decreasing the hue angle of the copper phthalocyanine pigment without the use of other color pigments or while decreasing the amount of other color pigments used. In this context, a dye having an absorption maximum wavelength at 380 to 450 nm in, for example, methyl ethyl ketone is preferred as the yellow fluorescent dye. A dye having a wavelength shorter than this range is less effective for rotating the hue angle (changing the hue).

Although colorless fluorescent dyes or yellow fluorescent dyes may be used either in the present invention, as mentioned above, preference is given to yellow fluorescent dyes again from viewpoints of other reasons. One of the reasons is that yellow fluorescent dyes, as compared with colorless fluorescent dyes, often have larger fluorescent emission intensity and largely improve the chroma by the addition of a small amount.

When a coating film is formed using only this fluorescent dye and the resin, it is preferred for the fluorescent dye of the present invention that the maximum wavelength of the coating film should fall within the range of 490 to 550 nm in reflection spectrum measurement mentioned later and that the maximum reflectance should be 90% or more. The maximum reflectance in the same wavelength region as above in the absence of the fluorescent dye is on the order of 20 to 80%. The difference between this reflectance and the reflectance 90% or more of the system containing the fluorescent dye makes human sight perceive greenishness or high chroma.

It is preferred for the yellow fluorescent dye according to the present invention that the reflection spectrum characteristics mentioned above should be 130% or less within the wavelength range mentioned above. A reflectance exceeding 130% is not preferred because the perception of hue difference by sight is large due to, for example, the difference in color temperature of the light source.

The yellow fluorescent dye used in the present invention is appropriately selected from among the chemical structures exemplified above for the optical brighteners as well as perylene, fluorescein, benzothiazole, benzimidazole, benzoxazole, rubrene, and pyranine dyes, etc. Such dyes are mostly classified into fat-soluble dyes, disperse dyes, water-soluble dyes, etc. From among them, the yellow fluorescent dye is appropriately selected and used.

In the present invention, for example, a fat-soluble dye such as C.I. Solvent Yellow 33, C.I. Solvent Yellow 98, C.I. Solvent Yellow 131, C.I. Solvent Yellow 135, or C.I. Solvent Yellow 160:1, a disperse dye such as C.I. Disperse Yellow 82, or a water-soluble dye such as C.I. Basic Yellow 40 is particularly preferably used as the yellow fluorescent dye.

In the present invention, the fluorescent dye is used at a ratio of 0.05 to 10 parts by weight relative to 100 parts by weight of the copper phthalocyanine. A fluorescent dye used at a ratio smaller than this range may be less effective for improving the chroma. Also, a fluorescent dye used at a ratio larger than this range may cause serious side effects such as large hue difference between different light sources.

The ratio of the fluorescent dye of the present invention to the copper phthalocyanine is more preferably 0.1 to 3.0 parts by weight relative to 100 parts by weight of the copper phthalocyanine, further preferably 0.1 to 2.5 parts by weight relative to 100 parts by weight of the copper phthalocyanine. These ranges are preferred from the viewpoint of decreasing the hue difference ΔE under light sources differing in color temperature.

The hue difference (ΔE) according to the present invention represents the difference in hue between a test condition and a comparative condition and is generally indicated by a spatial distance in the L*a*b* color space chart. This value is calculated according to the equation ΔE=[(ΔL*)²+(Δa*)²+(Δb*)²]^{1/2}. In general, when ΔE is 2.0 or less, the different colors of objects allegedly become difficult to distinguish by human sight.

The fluorescent dye according to the present invention is added in order to obtain desirable values as to the chroma or the hue. The color of the coating film thus prepared or its image forming pixels may be perceived differently under different environments (e.g., the color temperature of the light source) even for the same sample. Thus, it is also preferred that the fluorescent dye should be used in an amount where the influence depending on the environment is small. In general, ΔE exceeding 2 is allegedly required for human sight to recognize the difference. This is the case where objects differing in hue are observed under the same light source. In the case of the present invention, the hue difference of the same sample between different environments is of concern, rather than the hue difference between different samples. Generally accepted criteria regarding the comparison of the same sample between daylight color and bulb color are not found. However, even the same sample changes its hue in visual observation and, further, there are a few needs for observing the same printed matter under different light sources, the tolerance of the hue difference between different color light sources may thus be larger.

In the present invention, as a result of conducting various studies on the tolerance value of the hue difference between different light sources described above, it has been concluded that the difference in hue ΔE between, for example, the CIE standard light source D65 (color temperature=6500° K), which reportedly exhibits daylight color, and the room light-type light source A10 (color temperature=3000° K), which has a very different color temperature and is close to the bulb color, needs to be 10 or less. This is because ΔE around 10 reportedly corresponds to hue difference by 1 on the Munsell color chart, and neither large discrepancy nor a feeling of strangeness was perceived in actual observation. Thus, in the present invention, the difference in hue ΔE between the CIE standard light source D65 and the light source A10 close to room light (bulb color) is preferably 10 or less, particularly preferably 8 or less, further particularly preferably 6 or less. This is because such a degree of hue difference does not produce strongly perceivable difference even when observed under different color temperature light sources at separate sites or times.

The colorant of the present invention contains the copper phthalocyanine pigment, the fluorescent dye, and a binder. A binder that can disperse the pigment and the dye therein or can dissolve and retain the pigment and the dye therein is used. In the present invention, various polymers are preferably used according to intended applications. Any thermoplastic or thermosetting resin, radiation-curable resin, or the like may be used as such a polymer. Resins including polyolefins such as polyethylene, rubber polymers obtained by the addition polymerization of butadiene or the like, polystyrenes, acrylic polymers such as methyl methacrylate, various polyesters obtained by the condensation of various dihydric alcohols with dibasic carboxylic acids, polyamides obtained by the condensation of secondary amines with dibasic carboxylic acids, and polyurethanes are preferably used as examples of the thermoplastic polymer. Among them, a polyester, a styrene-acryl, a polyamide, or a urethane is particularly preferred in terms of solvent solubility, pigment dispersibility, physical/chemical stability, etc.

A resin three-dimensionally cross-linkable by heat or radiation, such as a polyfunctional acrylic acid monomer, an epoxy compound, or a phenol compound, is used as the thermosetting or radiation-curable resin of the present invention.

The ratio between the pigment and the resin in the colorant composition of the present invention largely differs depending on intended applications and is generally 0.5 to 40 parts by weight of, preferably 1 to 20 parts by weight of, more preferably 2 to 10 parts by weight of the pigment relative to 100 parts by weight of the resin. At a ratio less than this range, it is required to increase the film thickness for obtaining the necessary degree of coloring. This may reduce drying performance or may reduce image quality. A ratio exceeding the range mentioned above is not preferred because the mechanical strength of pixels or the like formed with the coloring materials, adhesion, etc. are reduced.

In addition to the copper phthalocyanine pigment, the fluorescent dye and the binder, the colorant composition of the present invention may appropriately comprise other additives in order to satisfy functions and physical properties necessary for each intended application. Examples of such additives include pigment dispersants, UV absorbers for improvement in light resistance, surfactants for improvement in coating properties, tackifiers for improvement in adhesion to substrates, etc., and waxes for controlling the heat characteristics or surface characteristics of colored coatings. Also, in the case of toner for printers, it is preferred to add a charge control agent for controlling the electrostatic characteristics. Furthermore, the amounts of the above additives added can be within ranges appropriate for each intended application.

As for the process for preparing the colorant composition of the present invention, various methods are possible according to the user's processing step or intended applications of the composition. For example, processes involving drying the copper phthalocyanine pigment, suitably crushing or pulverizing the pigment, and then, for example,
1) mixing the pigment with the fluorescent dye, the resin, and a solvent and dissolving or dispersing the mixture by an appropriate method,
2) charging a mixture of the pigment and the fluorescent dye into a container and mixing and dispersing the mixture into the resin and a solvent at a different site, or
3) dissolving or dispersing in advance the pigment, the resin, and a solvent and adding and dissolving a separately obtained dye alone
   can be arbitrarily selected according to intended applications or at the convenience of manufacturers or users.

However, the process for preparing the above colorant composition is not limited to the processes described above, and various processes can be used according to intended applications. In the case of, for example, electrophotographic toner, a process involving adding a monomer, an emulsifier, a polymerization initiator, and the like to a dispersion containing the copper phthalocyanine and the fluorescent dye and preparing the colorant composition by emulsion polymerization is also preferred.

Alternatively, the colorant composition may be prepared by dispersing the copper phthalocyanine pigment into the resin, granulating the dispersion and further adding the fluorescent dye to the granules. It is required that the pigment, the dye, and the resin of the present invention should be contained on the condition mentioned above in the colorant composition film (pixels) formed on, for example, printing paper.

### EXAMPLES

Hereinafter, the present invention will be described with reference to examples. However, the present invention is not intended to be limited by these examples.

### Example 1

The following colorant composition was prepared.

TABLE 1

| Cyan | PV Fast Blue BG | 0.6 | parts by weight |
|---|---|---|---|
| pigment | (Pigment Blue 15:3, | | |
| | manufactured | | |
| | by Clariant, | | |
| | unsubstituted β-copper | | |
| | phthalocyanine) | | |
| Fluores- | Solvent Yellow 160:1 | 0.0006 | parts by weight |
| cent | (LANXESS AG, Macrolex | (0.1 part by weight | |
| dye | Fluorescent Yellow 10GN) | relative to 100 parts by | |
| | | weight of the cyan pigment) | |
| Polyester | Reichhold Chemicals, Inc., | 10 | parts by weight |
| resin | product name: Finetone 382ES | | |
| Solvent | Tetrahydrofuran | 20 | parts by weight |

30 g of the composition described above was weighed and put into a 70-ml glass bottle. 70 g of glass beads having a diameter of 2 mm was weighed into the bottle and dispersed for 60 minutes using a vertical paint shaker to prepare pigment application sample A (ink). The ink thus prepared had a pigment concentration of 6%. This ink was developed onto coat paper (manufactured by Daio Paper Corp., trade name: Utrillo Coat, weighed amount: 157 g/m²) (actual value of whiteness measured with the spectrophotometer SPECTRO FLASH SF600: 86.05) using bar coater No. 2 and dried on a hot plate. The amount (wet) of a coating of the obtained application sample A1 was 12 μm. Furthermore, its cyan reflection density was 1.7 in a reflection density measurement apparatus (manufactured by Gretag-Macbeth Inc., SPECTOROEYE, gas filling-system tungsten lamp, illumination type A, no physical filter). Here, the absorption maximum wavelength of the yellow fluorescent dye Solvent Yellow 160:1 was 420 nm.

### Example 2

Pigment application sample A2 was obtained in the same way as in Example 1 except that the ratio of the fluorescent dye Solvent Yellow 160:1 was set to 0.25 parts by weight relative to 100 parts by weight of the copper phthalocyanine pigment.

### Example 3

Pigment application sample A3 was obtained in the same way as in Example 1 except that the ratio of the fluorescent dye Solvent Yellow 160:1 was set to 0.5 parts by weight relative to 100 parts by weight of the copper phthalocyanine pigment.

### Example 4

Pigment application sample A4 was obtained in the same way as in Example 1 except that the ratio of the fluorescent dye Solvent Yellow 160:1 was set to 1.0 part by weight relative to 100 parts by weight of the copper phthalocyanine pigment.

### Example 5

Pigment application sample A5 was obtained in the same way as in Example 1 except that the ratio of the fluorescent dye Solvent Yellow 160:1 was set to 2.0 parts by weight relative to 100 parts by weight of the copper phthalocyanine pigment.

### Example 6

Pigment application sample A6 was obtained in the same way as in Example 2 except that the fluorescent dye was changed to Solvent Yellow 98 (Clariant, Hostasol Yellow 3G).

### Comparative Example 1

Comparative pigment application sample B1 containing no fluorescent dye was obtained in totally the same way as in Example 1 except that the yellow dye Solvent Yellow 160:1 was not added.

### Comparative Example 2

Comparative pigment application sample B2 was obtained in the same way as in Example 1 except that the ratio of the fluorescent dye Solvent Yellow 160:1 was set to 11.0 parts by weight relative to 100 parts by weight of the pigment.

### Comparative Example 3

Comparative pigment application sample B3 was obtained in the same way as in Example 1 except that a green pigment PV Fast Green GNX (C.I. Pigment Green 7, manufactured by Clariant) was used instead of Solvent Yellow 160:1 and 11.1 parts by weight of the green pigment was used relative to 100 parts by weight of the cyan pigment.

### Comparative Example 4

Comparative pigment application sample B4 was obtained in the same way as in Comparative Example 3 except that 25 parts by weight of the green pigment was used relative to 100 parts by weight of the cyan pigment.

### Comparative Example 5

Comparative pigment application sample B5 was obtained in the same way as in Example 1 except that a yellow dye C.I. Solvent Yellow 93 (manufactured by Clariant, Solvaperm Yellow 3G) generating almost no fluorescence was used instead of Solvent Yellow 160:1 (the amount of the yellow dye relative to 100 parts by weight of the cyan pigment: 0.1 part by weight).

Evaluation of Pigment Application Sample

The samples A1 to A6 and the comparative samples B1 to B5 thus obtained were evaluated for their properties described below by the following methods.

1) Hue Evaluation
Color measurement was carried out at a viewing angle of 10° with D65 as a light source for measurement using a spectrophotometer [SPECTRA FLASH SF600 (manufactured by Data Color International)] to quantitatively evaluate lightness/chroma/hue angle(L*C*H). In this context, the hue is based on the definition of the color system specified by CIE (International Commission on Illumination). Each sample for hue measurement was uniformly applied and dried under the conditions described above. The area of the sample was 7 cm².

2) Evaluation of Change in Hue Depending on Light Source
In the hue evaluation described above, the measurement was carried out using both the standard daylight color light source (D65; color temperature=6500° K) and the room light-type light source A10 (color temperature=3000° K), and the hue difference (ΔE) between them was evaluated. In this context, the relationship between ΔE and sensory evaluation differs depending on the evaluation method thereof. In general, at hue differences of 2 or less, colors are reportedly difficult to distinguish by human sight. Furthermore, at ΔE within the range of 2.5 to 5.0, the general impression is that colors are perceived as almost the same colors unless compared side-by-side. At ΔE within the range of 6.5 to 13.0, colors differ by approximately 1 in the Munsell color chart, for example.

3) Visible Reflection Spectrum Measurement
A solution containing the resin, the fluorescent dye, and the solvent mixed without containing the copper phthalocyanine was applied and dried in the same way as mentioned above to prepare a reflection spectrum measurement sample. The measurement was carried out at a viewing angle of 10° with the light source D65 as a light source for measurement using a spectrophotometer [SPECTRA FLASH SF600 (manufactured by Data Color International)]. In this respect, standard white ceramic tiles (manufactured by Data Color International, manufacture lot serial #9197, average reflectance of visible light at 500 nm or more: 90% or more) attached to the spectrophotometer were used as the reference.

The obtained evaluation results are shown in Table 2. The values described in the column “Maximum reflectance of coating film (maximum wavelength)” in Table 2 are not values directly measured from the samples of Examples or Comparative Examples and are values measured under the conditions mentioned above from coating films each consisting of the dye and the polymer binder without containing the copper phthalocyanine pigment. The contents of Table 2 are summarized as follows.
1) The addition of 0.1 to 0.25 parts by weight of the fluorescent dye of the present invention relative to 100 parts by weight of the cyan pigment changes the hue angle by 2° and improves the lightness L by 0.2 to 0.7.
2) The addition of 0.5 to 2 parts by weight of the fluorescent dye of the present invention relative to 100 parts by weight of the cyan pigment improves the chroma by approximately 2 to 3.
3) As for the hue difference between the different color light sources, the addition of approximately 1 part by weight of the fluorescent dye causes ΔE to exceed 5, which is however a level that is generally not easy to recognize unless compared at the same site, and is sufficient for practical use.
4) When the amount of the fluorescent dye added is 2 parts by weight, ΔE is 7.5, which is however also a level that merely produces slightly different color (e.g., a level that differs by 1 in the Munsell color chart) when compared at the same site, and seemed to be practical.
5) An amount of the fluorescent dye added exceeding 10 parts by weight (Comparative Example 2) was considered to be unfavorable because the hue difference between different light sources was very large, though the chroma was high.
6) Furthermore, the addition of the non-fluorescent green pigment C.I. Pigment Green 7 (Comparative Examples 3 and 4) or the non-fluorescent dye C.I. Solvent Yellow 93 (Comparative Example 5) reduced both the chroma and the lightness, and showed tendency to increase ΔE between the different light sources.

TABLE 2

| | | | | | | Hue | |
|---|---|---|---|---|---|---|---|
| | | Part by | | | | difference | |
| | | weight | | | | between | Maximum |
| | | relative to | | | | light | reflectance of |
| Example/ | Dye/ | 100 parts | | | H | sources | coating film |
| Comparative | pigment | by weight | L* | C* | (hue | D65 and | (maximum |
| Example | added | of pigment | (lightness) | (chroma) | angle) | A10 | wavelength) |
| Comparative | None | 0 | 50.2 | 63.4 | 236.3 | 0.12 | — |
| Example 1 | | | | | | | (No |
| | | | | | | | fluorescence |
| | | | | | | | was observed) |
| Example 1 | SY160:1 | 0.1 | 50.4 | 63.6 | 234.4 | 1.38 | 106% |
| | | | | | | | (520 nm) |
| Example 2 | SY160:1 | 0.25 | 50.9 | 63.7 | 230.0 | 1.60 | 108% |
| | | | | | | | (520 nm) |
| Example 3 | SY160:1 | 0.5 | 50.3 | 65.5 | 224.5 | 3.45 | 117% |
| | | | | | | | (520 nm) |
| Example 4 | SY160:1 | 1.0 | 51.9 | 66.5 | 216.1 | 5.11 | 121% |
| | | | | | | | (520 nm) |
| Example 5 | SY160:1 | 2.0 | 50.3 | 66.8 | 190.3 | 7.52 | 126% |
| | | | | | | | (520 nm) |
| Example 6 | SY98 | 0.25 | 50.3 | 64.0 | 230.3 | 0.86 | 109% |
| | | | | | | | (530 nm) |
| Comparative | SY160:1 | 11.0 | 50.1 | 67.8 | 159 | 13.2 | 131% |
| Example 2 | | | | | | | (520 nm) |
| Comparative | PGr7 | 11.1 | 49.1 | 61.9 | 225.7 | 1.04 | 72% |
| Example 3 | | | | | | | (500 nm) |
| Comparative | PGr7 | 25 | 47.9 | 60.9 | 215.4 | 2.24 | 67% |
| Example 4 | | | | | | | (500 nm) |
| Comparative | SY93 | 0.1 | 49.5 | 62.3 | 228.7 | 0.33 | 85% |
| Example 5 | | | | | | | (550 nm) |

1. A colorant composition comprising a copper phthalocyanine pigment, a fluorescent dye, and a resin binder, wherein the hue angle of a coating from the composition on white paper is 236° or less, and the fluorescent dye provides a maximum reflectance of 90 to 130% in the visible reflection spectrum of a coating film consisting of the fluorescent dye and the resin binder without comprising the copper phthalocyanine pigment.

2. A colorant composition as claimed in claim 1, wherein the amount of the fluorescent dye is 0.05 to 10 parts by weight relative to 100 parts by weight of the copper phthalocyanine pigment.

3. A colorant composition as claimed in claim 1, wherein the copper phthalocyanine pigment comprises unsubstituted copper phthalocyanine.

4. A colorant composition comprising a copper phthalocyanine pigment, a fluorescent dye, and a resin binder, wherein
the copper phthalocyanine pigment includes unsubstituted copper phthalocyanine,
the fluorescent dye includes a yellow fluorescent dye, and
the amount of the fluorescent dye is 0.05 to 10 parts by weight relative to 100 parts by weight of the copper phthalocyanine pigment.

5. A colorant composition as claimed in claim 4, wherein the hue angle of a coating therefrom on white paper is 236° or less.

6. A colorant composition as claimed in claim 4, wherein the fluorescent dye provides a maximum reflectance of 90 to 130% in the visible reflection spectrum of a coating film consisting of the fluorescent dye and the resin binder without comprising the copper phthalocyanine pigment.

7. A colorant composition as claimed in claim 1, wherein the maximum reflection wavelength in the visible reflection spectrum of a coating film consisting of the fluorescent dye and the resin binder falls within the range of 490 to 550 nm.

8. A colorant composition as claimed in claim 1, wherein the copper phthalocyanine pigment comprises β-copper phthalocyanine.

9. A colorant composition as claimed in claim 1, wherein the absorption maximum wavelength of the fluorescent dye falls within the range of 380 to 450 nm.

10. A colorant composition as claimed in claim 1, wherein the fluorescent dye does not have an absorption at a wavelength longer than 450 nm.

11. A colorant composition as claimed in claim 1, wherein the fluorescent dye is selected from the group consisting of a coumarin, a stilbene, and a naphthalimide.

12. A colorant composition as claimed in claim 1, wherein the fluorescent dye is a dye selected from the group consisting of Solvent Yellow 98, Solvent Yellow 160:1, Solvent Yellow 33, Solvent Yellow 98, Solvent Yellow 131, and Solvent Yellow 135.

13. A colorant composition as claimed in claim 1, wherein the resin binder is selected from the group consisting of a polyolefin, a polyester, a polystyrene derivative, an acrylic resin derivative, a styrene-acryl copolymer, and a urethane resin derivative.

14. A colorant composition as claimed in claim 1, wherein when the colorant is applied onto white paper, the hue difference ΔE between the hue of the coating under the daylight color light source D65 (color temperature=6500° K) and the hue under the room light-type light source A10 (color temperature=3000° K) is 10 or less.

15. A pigment composition for use in preparing a colorant composition, the pigment composition comprising an unsubstituted copper phthalocyanine pigment, a resin binder and a yellow fluorescent dye, wherein the composition comprises 0.05 to 10 parts by weight of the yellow fluorescent dye relative to 100 parts by weight of the unsubstituted copper phthalocyanine pigment.

16. A method for forming an image on a paper substrate comprising the step of applying a colorant composition as claimed in claim 1 to the paper substrate.
